(19) United States
(12) Patent Application Publication
(10) Pub. No.: US 2010/0133987 A1
(43) Pub. Date: Jun. 3, 2010

(54) PHOSPHOR AND WHITE LIGHT ILLUMIANTION DEVICE UTILIZING THE SAME

(75) Inventors: Tien-Heng Huang, Yongkang City (TW); Yao-Tsung Yeh, Taoyuan City (TW); Fang-Ching Chang, Yongkang City (TW); Shian-Jy Jassy Wang, Hsinchu County (TW)

Correspondence Address: PAI PATENT & TRADEMARK LAW FIRM, 1001 FOURTH AVENUE, SUITE 3200, SEATTLE, WA, 98154, US

(73) Assignee: INDUSTRIAL TECHNOLOGY RESEARCH INSTITUTE, Hsinchu County (TW)

(21) Appl. No.: 12/391,276

(22) Filed: Feb. 24, 2009

(30) Foreign Application Priority Data
Dec. 2, 2008 (TW) 097146729

(51) Int. Cl. H01J 1/62; C09K 11/77; C09K 11/54

(52) U.S. Cl. 313/503; 313/483; 252/301.6 R; 252/301.4 R

(57) ABSTRACT

The invention provides phosphors composed of EuMg₍₁₋ₓ₎MaₓMb₁₀O₁₇, wherein Ma is Mn, Zn, or combinations thereof, Mb is Al, Ga, B, In, or combinations thereof, and O<x<0.7. These phosphors emit visible light under the excitation of ultraviolet light or blue light, and these phosphors may be further collocated with different color phosphors to provide a white light illumination device. Alternatively, the phosphors of the invention can improve the efficient utilization of the light in solar cell.

### CROSS REFERENCE TO RELATED APPLICATIONS

This Application claims priority of Taiwan Patent Application No. 97146729, filed on Dec. 2, 2008, the entirety of which is incorporated by reference herein.

### BACKGROUND OF THE INVENTION

1. Field of the Invention

The present invention relates to phosphors, and in particular relates to white light illumination device and solar cells utilizing the same.

2. Description of the Related Art

White light emitting diodes is major stream of modern illumination due to its energy-saving, low pollution, and long lifetime. The critical points of total luminous efficiency in the illumination devices are not only LED inherent brightness but also the LED phosphors.

The general commercially available white light LED is blue LED (emission wavelength of 460 nm to 480 nm) collocating yellow phosphor, thereby having worse color-rendering. In addition, the yellow light comes from the yellow phosphor excited by the blue light from the blue LED chips. Because the blue light intensity is changed by different input current, the white light will tends to yellow or blue. Furthermore, the white light color will be uneven due to blue LED chips gradually damaged by time. For improving color-rendering and luminous efficiency, the UV light emitting diode is usually adopted with red, blue, and green phosphors. Because the excitation light source is invisible light, the white light color will not be influenced by excitation light source intensity decreasing.

In U.S. Pat. Nos. 7,064,480 and 7,239,082 and World Pat. No. 0211211, a blue-green phosphor aluminate EuMgAl₁₀O₁₇ is disclosed. The phosphor is excited by an major excitation peak of 396 nm to emit a blue-green light having a major emission peak of 477 nm. However, the strongest emission intensity of this phosphor is poor.

Accordingly, the phosphor composition should be tuned to enhance its strongest emission intensity. Moreover, pure red, pure green, and pure blue phosphors are called for.

### BRIEF SUMMARY OF THE INVENTION

The invention provides a phosphor, having a formula of EuMg₍₁₋ₓ₎MaₓMb₁₀O₁₇, wherein Ma is Mn, Zn, or combinations thereof; Mb is Al, Ga, B, In, or combinations thereof; and 0<x<0.7.

The invention also provides a white light illumination device, comprising the phosphor as claimed in claim 1 and an excitation light source, wherein the excitation light source emits 200-400nm UV or 400-420 nm blue light.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows the solar cell in one embodiment of the invention;

FIG. 2 shows the comparison between the emission spectra of the phosphor EuMg₁₋ₓMnₓAl₁₀O₁₇ in the invention and the conventional phosphor EuMgAl₁₀O₁₇;

FIG. 3 shows a CIE diagram of the phosphor EuMg_{0.7}Mn_{0.3}Al₁₀O₁₇ in one embodiment of the invention;

FIG. 4 shows the different photoluminescence intensities of EuMg₁₋ₓMnₓAl₁₀O₁₇ with different x ratio; and

FIG. 5 shows the comparison of excitation and emission spectra between phosphors EuMg_{0.8}Mn_{0.2}A_{(10-y)}Ga_{y}O₁₇ with different y ratio.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The invention provides a phosphor having a formula of EuMg₍₁₋ₓ₎MaₓMb₁₀O₁₇, wherein Ma is Mn, Zn, or combinations thereof; Mb is Al, Ga, B, In, or combinations thereof; and 0<x<0.7. In one embodiment, the phosphor can be EuMg₍₁₋ₓ₎MnₓAl₁₀O₁₇. In another embodiment, the phosphor can be EuMg_{0.8}Mn_{0.2}Al_{(10-y)}Ga_{y}O₁₇, wherein 0<y<5.

The phosphor can be excited by 200-400 nm UV or 400-420 nm blue light to emit a green light. The green light has a major emission peak of about 515 nm. The excitation light source applied to emit UV or blue light includes a light emitting diode or a laser diode.

The method for preparing the described phosphor is solid-reaction. First, the appropriate stoichiometry of reagents was weighted according to the element molar ratio of resulting phosphor:EuMg₍₁₋ₓ₎MaₓMb₁₀O₁₇, wherein Ma is Mn, Zn, or combinations thereof, and Mb is Al, Ga, B, In, or combinations thereof. The reagents containing Mg can be oxides such as MgO, carbonates such as MgCO₃, or chlorides such as MgCl₂. The reagents containing Al, Ga, or In can be oxides such as γ-Al₂O₃, Ga₂O₃, or In₂O₃. The reagents containing Eu²⁺, Mn²⁺, Zn²⁺, or combinations thereof can be chlorides such as EuCl₂, oxides such as Mn₃O₄, ZnO, or MnO, carbonates such as MnCO₃, or acetate such as Mn(CH₃COO)₂. The reagents containing boron can be boron oxide (B₂O₃) or boric acid (H₃BO₃). The described reagents of appropriate equivalent were evenly mixed and grinded, and charged in a crucible. The crucible was then heated in a high temperature furnace. After sintering at 1400-1700° C. for several hours, the described phosphor was prepared.

In one embodiment, the phosphor is excited by blue light or UV to emit green light. As such, the phosphor of the invention may collocate with UV excitable blue phosphor and UV/blue light excitable red phosphor. Arranged with an ultraviolet excitation light source such as a light-emitting diode or laser diode, a white light emitting diode or white laser diode is completed. The blue phosphor includes BaMgAl₁₀O₇:Eu^{2+, (Ba,Sr,Ca)}₅(PO₄)₃(F,Cl,Br,OH):Eu²⁺, 2SrO*0.84P₂O₅*0.16B₂O₃:Eu²⁺, Sr₂Si₃O₈*2SrCl₂:Eu²⁺, (Mg,Ca,Sr,Ba,Zn)₃B₂O₆:Eu²⁺, or other suitable blue phosphors. The red phosphor includes (Sr,Ca)S:Eu²⁺, (Y,La,Gd,Lu)₂O₃:Eu³⁺,Bi³⁺, (Y,La,Gd,Lu)₂O₂S:Eu³⁺,Bi³⁺, Ca₂Si₅N₈:Eu²⁺, ZnCdS:AgCl, or other suitable red phosphors. The red and blue phosphors can be divided into being directly or indirectly excitable. If the red, green, and blue phosphors are near UV excitable, they are directly excited by an excitation light source such as a light emitting diode or laser diode. If the red and green phosphors are blue light excitable, they are indirectly excited by blue light. The blue light is emitted from the blue phosphor excited by an excitation light source such as a light emitting diode or laser diode. The combination and ratio of red, green, and blue phosphors are optional in different applications of direct or indirect excitation.

In the white light illumination device as described above, a white light emitting diode or white laser diode, and the red/green/blue phosphors can be evenly mixed in preferable ratio and dispersed in an optical gel. The optical gel containing the phosphors may further seal a near UV excitation light source such as a chip of a light emitting diode or a laser diode. Note that if UV is selected as the excitation light source, an UV filter or other UV insulator should be arranged externally from the white light illumination device to protect user's eyes and skin.

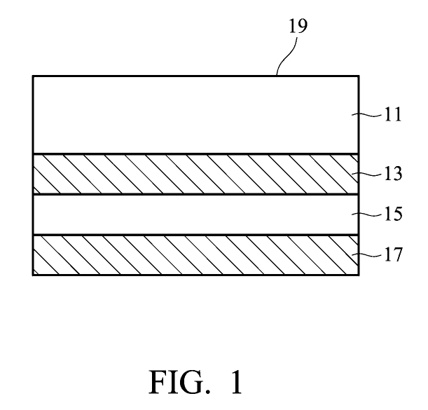

Besides white light emitting diode, the UV excitable phosphor of the invention can be applied to a solar cell. As shown in FIG. 1, a typical solar cell includes a transparent substrate 11. An anode 13, a semiconductor layer 15, and a cathode 17 are sequentially formed on the transparent substrate 11. In general, the transparent substrate 11 is glass, plastic, or synthetic resin. The anode 13 is a transparent conductive layer such as indium tin oxide (ITO), zinc oxide, tin fluoride oxide, or combinations thereof. The semiconductor layer 15 can be single or multi-layered PIN structure including p-type doped (so called P layer), non-doped (so-called I layer), and n-type doped (so-called N layer) semiconductor material. The semiconductor material can be hydrogenated amorphous silicon or hydrogenated microcrystalline silicon. The cathode 17 is aluminum, silver, molybdenum, platinum, copper, gold, iron, niobium, titanium, chromium, bismuth, antimony, and the likes. Most of the semiconductor layers utilize visible light other than higher energy UV. The phosphor of the invention can be formed on top surface 19 of the transparent substrate 11, thereby transforming UV to visible green light to enhance the light efficient utilization of the semiconductor layer 15 in the solar cell.

### EXAMPLES

### Example 1

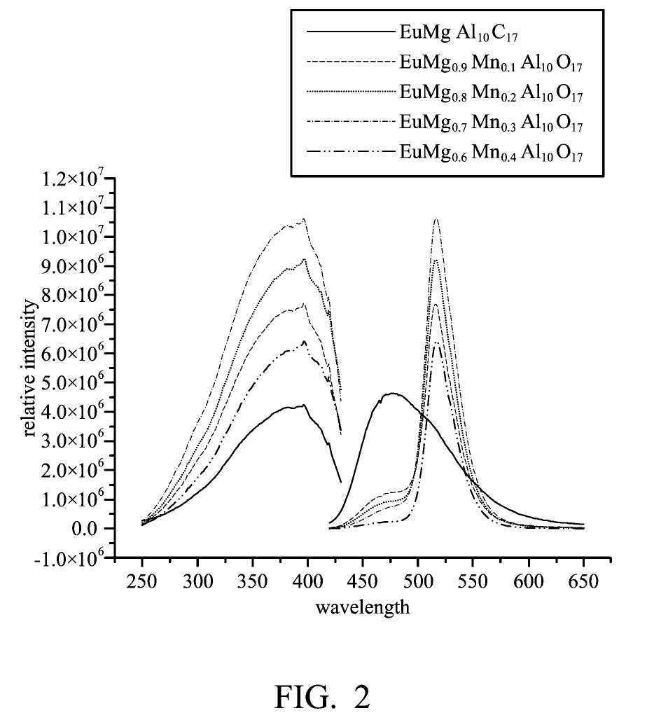

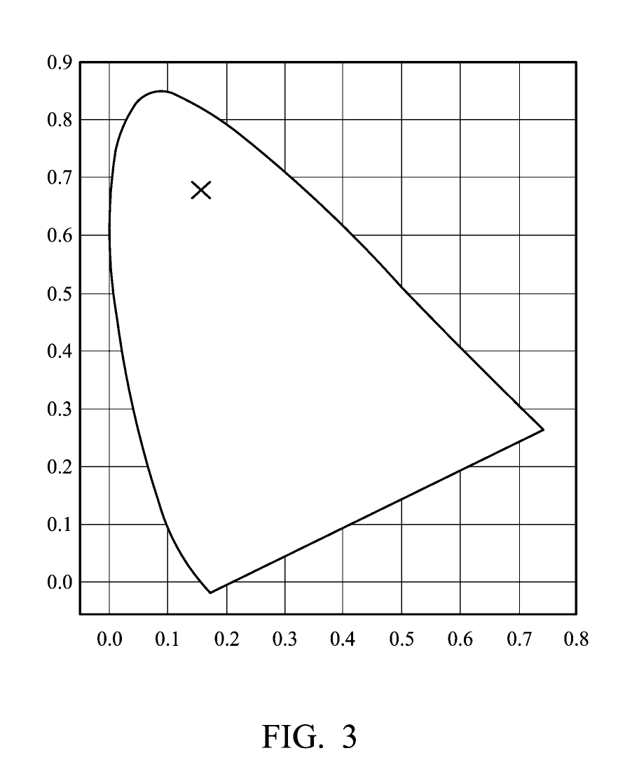

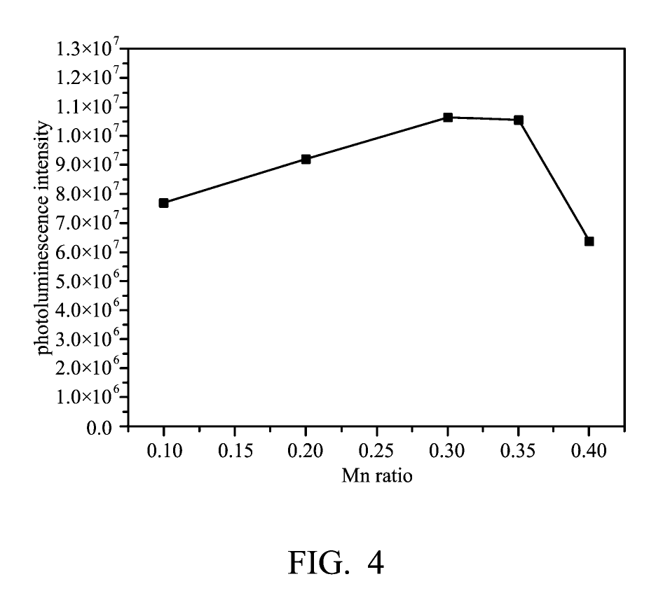

According to chemical stoichiometry, the appropriate amount of Eu₂O₃ (commercially available from Aldrich Chemicals Company Inc. in U.S.A., 99.99%, FW=351.92), MgO (commercially available from Aldrich Chemicals Company Inc. in U.S.A., 99.99%, FW=40.3), MnCO₃ (commercially available from Aldrich Chemicals Company Inc. in U.S.A., 99.99%, FW=114.93), and Al₂O₃ (commercially available from Aldrich Chemicals Company Inc. in U.S.A., >99.9%, FW=101.96) were evenly mixed and grinded, charged in a crucible, and heated in a high temperature furnace. After sintering at 1600° C. for 8-12 hours under 5% H₂/N₂, the phosphor EuMg_{0.9}Mn_{0.1}Al₁₀O₁₇, EuMg_{0.8}Mn_{0.2}Al₁₀O₁₇, EuMg_{0.7}Mn_{0.3}Al₁₀O₁₇, and EuMg_{0.6}Mn_{0.4}A1₁₀O₁₇ were prepared. The emission spectra comparison of the above products and conventional phosphor EuMgAl₁₀O₁₇ was shown in FIG. 2. The described phosphors have a major excitation peak of 396 nm and a major emission peak of 515 nm to 517 nm, wherein the major emission peak has a CIE coordination (0.157, 0.667) as shown in FIG. 3. Compared to the conventional phosphor EuMgAl₁₀O₁₇ without dopant, the phosphors of the invention has longer emission wavelength. For example, the strongest emission intensity of EuMg_{0.7}Mn_{0.3}Al₁₀O₁₇ (1*10⁷ counts.) is 100% higher than that of the EuMgAl₁₀O₁₇ (5*10⁶ counts.). FIG. 4 shows the photoluminescence intensity influenced by the different Mn ratio in phosphor EuMg_{(1-x)Mn}ₓAl₁₀O₁₇. The photoluminescence intensity is enhanced by increasing the Mn ratio until x equal to 0.3. When Mn ratio is greater than 0.3, the photoluminescence intensity is reduced by increasing the Mn ratio. Note that the phosphor corresponding to FIG. 4 is prepared at 1600° C. for 8 hours. The best Mn ratio (x) of the other EuMg₍₁₋ₓ₎MnₓAl₁₀O₁₇ is determined by sintering temperature and period, not limited by the best ratio of FIG. 4.

### Example 2

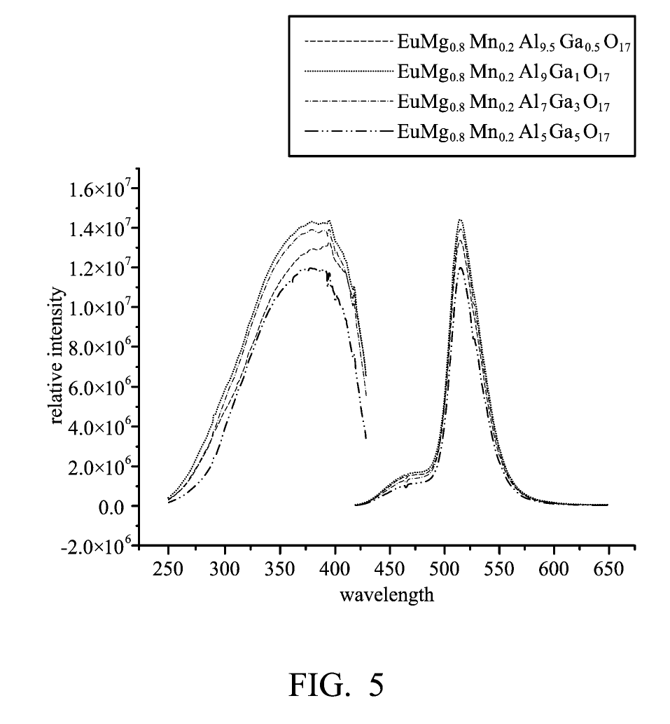

According to chemical stoichiometry, the appropriate amount of Eu₂O₃ (commercially available from Aldrich Chemicals Company Inc. in U.S.A., 99.99%, FW=351.92), MgO (commercially available from Aldrich Chemicals Company Inc. in U.S.A., 99.99%, FW=40.3), MnCO₃ (commercially available from Aldrich Chemicals Company Inc. in U.S.A., 99.99%, FW=114.93), A1₂O₃ (commercially available from Aldrich Chemicals Company Inc. in U.S.A., >99.9%, FW=101.96), and Ga₂O₃ (commercially available from Aldrich Chemicals Company Inc. in U.S.A., >99.9%, FW=187.44) were evenly mixed and grinded, charged in a crucible, and heated in a high temperature furnace. After sintering at 1600° C. for 8-12 hours under 5% H₂/N₂, the phosphor EuMg_{0.8}Mn_{0.2}Al_{9.5}Ga_{0.5}O₁₇, EuMg_{0.8}Mn_{0.2}Al₉GaO₁₇, EuMg_{0.8}Mn_{0.2}Al₇Ga₃O₁₇, and EuMg_{0.8}Mn₀₂Al₅Ga₅O₁₇ were prepared. The excitation and emission spectra comparison of the above products was shown in FIG. 5. The described phosphors have a major excitation peak of 380 nm to 396 nm and a major emission peak of 515 nm, wherein the major emission peak has a CIE coordination (0.155, 0.615). Accordingly, the Mb of EuMg₍₁₋ₓ₎MaₓMb₁₀O₁₇ is not only Al but also optionally doped by other IIIA group elements such as Ga.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A phosphor, having a formula:
EuMg₍₁₋ₓ₎MaₓMb₁₀O₁₇,
wherein Ma is Mn, Zn, or combinations thereof;
Mb is Al, Ga, B, In, or combinations thereof; and
0<x<0.7.

2. The phosphor as claimed in claim 1 comprising EuMg₍₁₋ₓ₎MnₓAl₁₀O₁₇.

3. The phosphor as claimed in claim 2 being EuMg_{0.7}Mn_{0.3}Al₁₀O₁₇, wherein the phosphor is excited by 200-400 nm UV or 400-420 nm blue light to emit a green light, and the green light has a major emission peak of about 515 nm and a CIE coordination of (0.157, 0.677).

4. The phosphor as claimed in claim 1 comprising EuMg_{0.8}Mn_{0.2}Al_{(10-y)}Ga_{y}O₁₇, wherein 0<y<5.

5. The phosphor as claimed in claim 4 being EuMg_{0.8}Mn_{0.2}Al₉GaO₁₇, wherein the phosphor is excited by 200-400 nm UV or 400-420 nm blue light to emit a green light, and the green light has a major emission peak of about 515 nm and a CIE coordination of (0.155, 0.615).

6. The phosphor as claimed in claim 1 being applied to a solar cell.

7. A white light illumination device, comprising the phosphor as claimed in claim 1 and an excitation light source, wherein the excitation light source emits 200-400 nm UV or 400-420 nm blue light.

8. The white light illumination device as claimed in claim 7, wherein the excitation light source comprises a light emitting diode or a laser diode.

9. The white light illumination device as claimed in claim 8, further comprising a blue phosphor and a red phosphor.

10. The white light illumination device as claimed in claim 9, wherein the blue phosphor comprises BaMgAl₁₀O₁₇:Eu²⁺, (Ba,Sr,Ca)₅(PO₄)₃(F,Cl,Br,OH):Eu²⁺, 2SrO*0.84P₂O₅*0.16B₂O₃:Eu²⁺, Sr₂Si₃O₈*2SrCl₂:Eu²⁺, or (Mg,Ca,Sr,Ba,Zn)₃B₂O₆:Eu²⁺.

12. The white light illumination device as claimed in claim 10, wherein the red phosphor comprises (Sr,Ca)S:Eu²⁺, (Y,La,Gd,Lu)₂O₃:Eu³⁺,Bi³⁺, (Y,La,Gd,Lu)₂O₂S:Eu³⁺,Bi³⁺, Ca₂Si₅N₈:Eu²⁺, or ZnCdS:AgCl.
